(19) United States
(12) Patent Application Publication
(10) Pub. No.: US 2009/0241324 A1
(43) Pub. Date: Oct. 1, 2009

(54) Tool for installing flexible strand like material in a split harness wrap

(75) Inventors: Sam Jang, Morton Grove, IL (US); Robert M. Reisel, Morton Grove, IL (US); Selvedina Mehmedagic, Morton Grove, IL (US)

Correspondence Address: James Faeir;Faier & Faier, Suite 600, 566 W Adams St, Chicago, IL, 60661, US

(73) Assignee: Richco Inc., Morton Grove, IL (US)

(21) Appl. No.: 11/596,399

(22) PCT Filed: May 12, 2005
(86) PCT No.: PCT/US05/16684

§ 371 Date: Nov. 13, 2006

Related U.S. Application Data
(60) Provisional application No. 60/570,234, filed on May 12, 2004.

(51) Int. Cl. B23P 19/04

(52) U.S. Cl. 29/728

(57) ABSTRACT

A tool for installing flexible strand like material in a split harness wrap, wherein the tool is capable of handling harnesses of selectively different diameters, and in which the tool is formed in sections adapted for folding in mating relationship over lengths of cable to be wrapped. The tool has ridges or tracks for spreading the harness open and receiving the selected harness arranged over the cable.

This application claims priority from U.S. Provisional Patent Application Ser. No. 60/570,234 filed 12 May 2004.

This invention relates to a tool for installing flexible strand like material in a split harness wrap, and is more particularly involved in such a tool which is adequately versatile to handle such cable and like flexible material like into lengths of split harness wrap of various diameters, without. the need for modifying the tool in any way.

### BACKGROUND AND SUMMARY OF THE INVENTION

Flexible split harness has become important for organizing and protecting flexible strand-like materials used in computers and other machines as well as automobiles and in various field installations. For example, typical harnesses are disclosed in the following prior art patents:

Babini U.S. Pat. No. 6,655,014, granted Dec. 2, 2003, for DEVICE FOR INSERTING WIRES AND/OR PIPES IN A TUBULAR FLEXIBLE SHEATH PROVIDED WITH OVERLAPPING EDGES;

Hegler U.S. Pat. No. 4,513,787, granted Apr. 30, 787, for CORRUGATED SHEATHING HOSE;

Kawamura U.S. Pat. No. 6,034,329, granted Mar. 7, 2000, for CORRUGATED TUBE AND AN AUTOMATIC WIRE-LOADING DEVICE THEREFORE;

Kawamura U.S. Pat. No. 6,317,968, granted Nov. 20, 2001, for CORRUGATED TUBE AND AN AUTOMATIC WIRE-LOADING DEVICE THEREFORE;

These harnesses are preferably very tough, so that they will support and protect the critical wire-like load they are intended to contain. Usually the harnesses are fabricated from dense plastic materials so that they are capable of protecting the underlying wire or tube. Also, it is important that the harness material be closed once the length of wire or the like is inserted into the harness. Preferably, the harness is fabricated from plastic, so that it has the ability to hold the wire without danger of cutting it and causing a short if the strand carries a current. The harness must also be of a structure so that if multiple lengths of strands are inserted into the harness, one or more lengths can exit the harness at selected points along the length of harness.

Another substantial problem in dealing with harness enclosures is that the harnesses may be of various diameters, depending upon the number and sizes of strands to be enclosed, and sometimes harnesses of different size are necessary to neatly connect a single device, like a computer or other piece of electronic equipment. Known tools, as exemplified by Babini U.S. Pat. No. 6,655,014 and Kawamura U.S. Pat. No. 6,317,968 and other prior art patents, are only capable of dealing with harness of a single diameter and are not adequately versatile to deal with harnesses of varying diameters. Thus, in the prior art, a different tool was required for each size harness, and that results in inefficiency and down time while changing tools as required.

A tool embodying the present invention can accommodate harness of varying sizes, because it has means built into it for holding and channeling each size of harness over the underlying cable or the like intended to be contained. This tool also permits the strand to leave the harness bundle along its length as desired. These features are accomplished by providing novel longitudinally extending ridges on the exterior of the tool which are intended to train the harness as desired.

Additionally, the tool embodying this invention has fool proof means for receiving and containing the strands of cable or the like by means of its novel construction. The tool is preferably molded in sections and the sections are hinged to one another in the direction of the strands to be harnessed, so that the sections are folded at the hinge over the strands, and once folded the strands cannot escape containment unless intentionally moved during the harnessing of them. The tool sections have novel closure means so that the closure is positive, and the strands do not move from within the closed tool. This molded sectional device also permits the enclosure of the strands of cables or the like without extra closure steps requiring twisting or special locking of the tool, as was typical of prior art devices and also had inherent in its design the possibility of untwisting and allowing the strands of cable or some of them to escape, as desired. The novel tool likewise provides positive ergonomic handle means, which allows for easy manipulation of the harness over the strands.

### OBJECTS AND ADVANTAGES OF THE INVENTION

It is therefore an object of the invention to provide a tool of the character described for installing flexible stand like material in a split harness wrap.

Another object is to provide a harness wrapping tool which can efficiently handle harness of varying diameters.

Another object is to provide a harness wrapping tool which has novel longitudinally extending ridges on its exterior for holding and training variable harnesses over strands of material to be wrapped.

Another object is to provide a harness wrapping tool which is formed in sections adapted for mating together.

Another object is provide a harness wrapping tool which has sections joined by a hinge for locating a desired mating position when the section are manipulated toward one another on an axis defined by the hinge.

Another object is to provide a multi-section harness wrapping tool which is adapted to accommodate a strand of material to be wrapped when the sections are manipulated together.

Another object is to provide a multi-section harness wrapping tool which has positive releasably secured means for holding the sections in harness wrapping condition.

Another object is to provide a harness wrapping tool which has means for selective easy exit of one or more strands from a body of wrapped strands.

Another object is to provide a harness wrapping tool which is relatively easy and inexpensive to manufacture and which is efficient and simple to use.

These and other objections and advantages will become more apparent as this description proceeds taken in conjunction with the accompanying drawings.

### BRIEF DESCRIPTION OF THE DRAWINGS

In the drawings:

FIG. 1 is a perspective view of a computer and monitor with unwrapped cable strands.

FIG. 2 is a perspective view similar to FIG. 1, with the cable strands wrapped according to the present invention.

FIG. 3 is a perspective view showing the wrapping of cable strands according to the present invention.

FIG. 4 is an elevational view of the interior of an unfolded tool embodying the invention.

FIG. 5 is an elevational view of the exterior of an unfolded tool embodying the invention.

FIG. 6 is a perspective view of the folded tool embodying the invention, viewed from its rear.

FIG. 7 is a perspective view of the folded tool embodying the invention viewed from its forward side.

### DESCRIPTION OF A PREFERRED EMBODIMENT

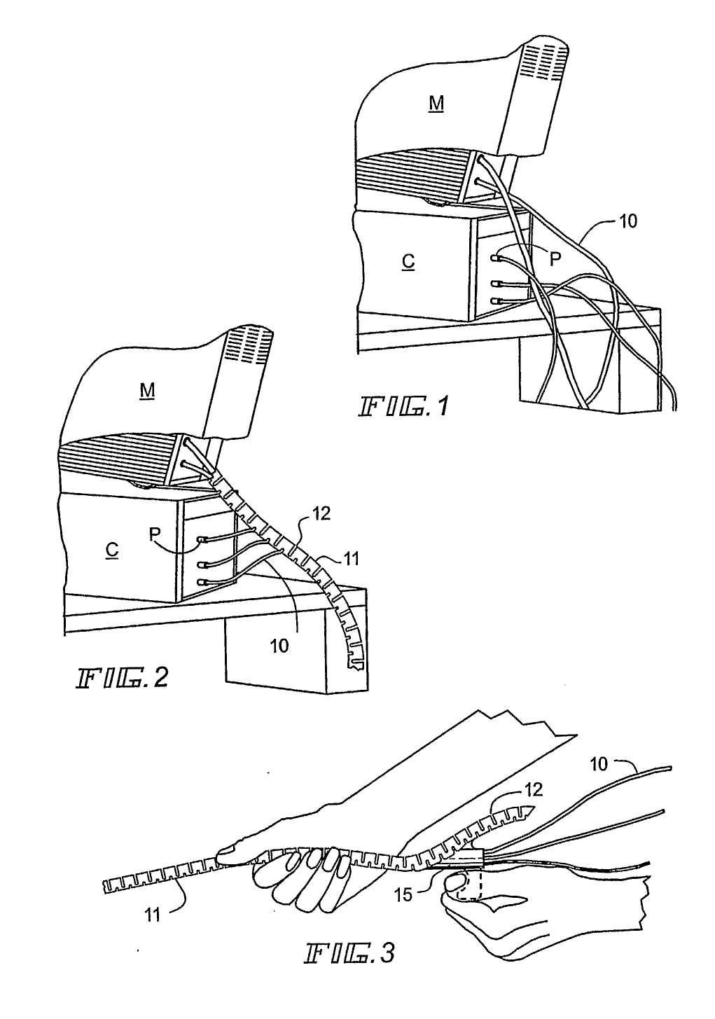

With reference to FIGS. 1-2, a computer C or Monitor M or similar equipment usually has many cables 10 or wire like strands connecting various ports P, and without some means for restricting their movement, these cables 10 are not only unattractive, but also dangerous when hanging loose, not only dangerous to the equipment, but also providing risk of tripping or falling to persons in the vicinity of the cables. To avoid these problems, it is desirable to encase the cables in a harness 11. Preferably the harness 11 has spaced apart openings 12, which not only provide flexibility to the harness, but also provide exit means for withdrawing selected cables from the harness bundle. It is desirable to fabricate the harness 11 from plastic material, so that it will protect the cables 10, particularly where the cables carry an electrical charge. To provide suitable closure for the harness 11 along its length, preferably the harness is biased in a closed position, and not easily opened to permit escape of the cables 10 from the harness. By the same token, since the harness 11 is biased closed, means must be provided to open it for encasing selected cables 10, as desired.

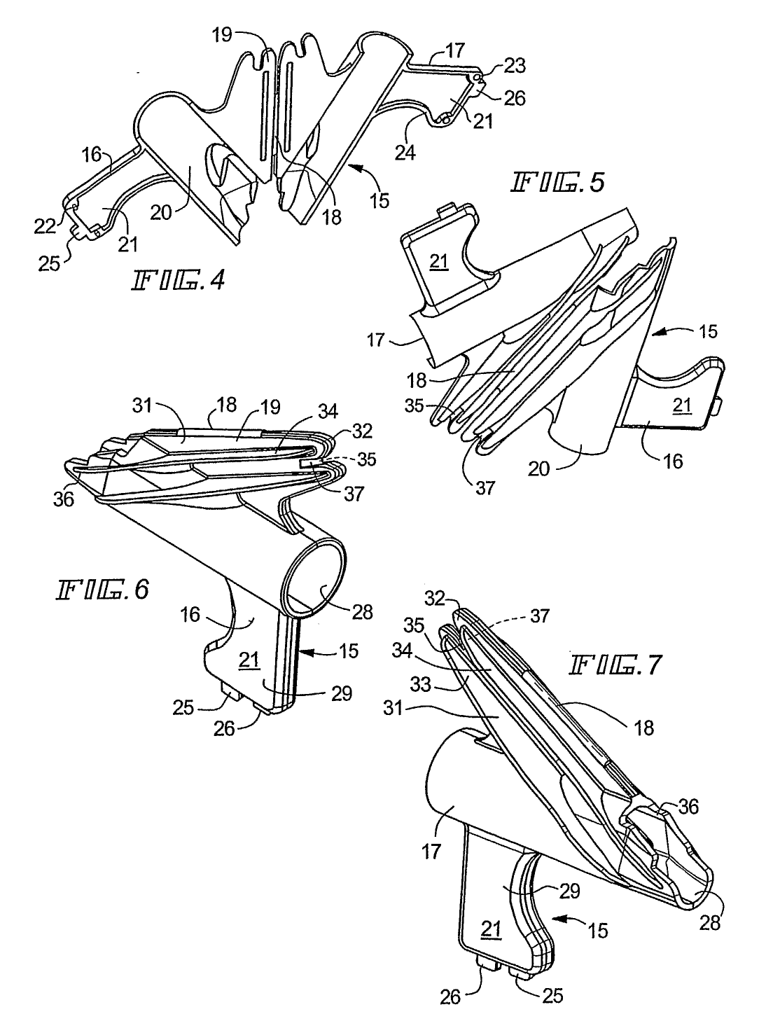

As shown in FIG. 3, a tool 15 is provided which may be hand held and allows opening of the harness 11 and admission of one or more lengths of the cables 10 into the opened length of harness.

With reference to FIG. 4, this tool 15 is molded into a male section 16 and a corresponding female section 17, joined together by a hinge 18 along complementary walls 19 of each section 16 and 17. The sections 16 and 17 define channel portions 20 and handle portions 21. The interior of the handle portion 21 of the male section 16 has upstanding posts 22 and the handle portion of the female section 17 has recesses 23 arranged correspondingly to the posts when the sections are folded together along the axis defined by the hinge 18. Along the peripheries 24 of handle portions 21 are complementary tabs 25 and 26 arranged to snap over the periphery of the opposed handle portion, to lock the removably lock the sections 16 and 17 together. Midway between the hinge 18 and the handle portions 21, when the sections are brought together, longitudinally of the tool 15, is a barrel 28 for receiving the cable 10, in a manner to be described.

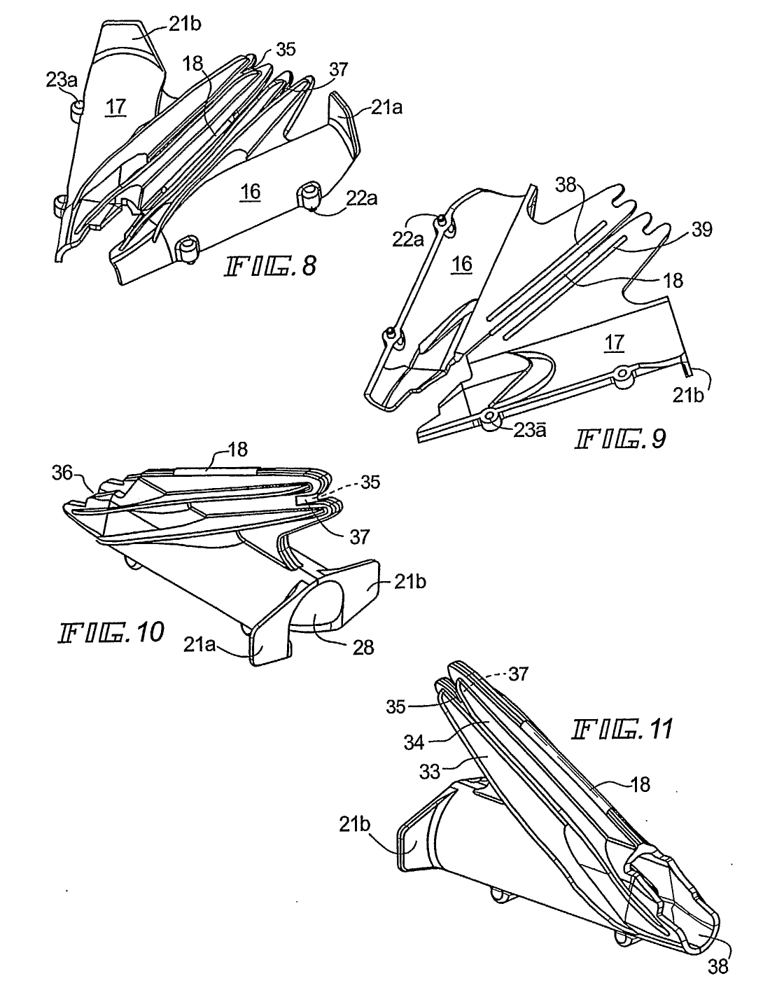

As shown in FIG. 5, the exterior of the sections 16 and 17 define a pistol grip 29, when the tool is assembled. Exteriorly of the tool 15, an angular platform 31 is formed when the sections are mated. This platform 31 is preferably arranged angularly to the barrel 28, and the entry side or end 32 of the platform is elevated above the barrel. The angular platform 31 has fist parallel ridges 33 and second parallel ridges 34, and these ridges are tapered from the entry side 32 of the tool 15 to its exit side 36. The entry side or end 32 of the platform 31 has niches 35 and 37 one associated with each set of parallel ridges 33 and 34. The exit side 36 of the barrel 28 is tapered in line with the angular platform 31. Preferably, the ridges 33 and 34 may be of different sizes, one associated with the diameter of one set of harness and the other associated with the diameter of a larger harness. A set of ridges like ridges 33 or 34 can be provided for each diameter of harness to be used in associated with the tool 15.

In use, the male and female sections 16 and 17 of the tool 15 are folded at the hinge 18, so that the cable 10 is within the barrel 28 formed by the mated channel portions 20, releasably locked together by means of the posts and recesses 22 and 23 and tabs 25 and 26. A section of harness 11 selectively sized to fit and be spread open by one of the associated niches 32 is engaged over the first or second set of platform ridges 33 or 34, depending upon the predetermined diameter size of the harness, at the entry side 32 of the platform 31. The handle portions 21 may be grasped with one hand and the harness may be manipulated with the other hand to move it over the platform 31 and out o f the exit side 30 of the platform, thus encasing the cable 10 within the harness 11, as shown in FIG. 3. If a cable 10 is to exit the harness 11 intermediate its length, the cable is trained out of the grouped cables through a harness opening 12.

While a preferred embodiment of the invention has been shown, it should be understood that many changed in the structure may be made without departing from the spirit or scope of the invention. Accordingly, it is not desired that the invention should be limited to the exact structure shown and described.

We claim:

1. A tool for installing flexible strand like material in a split harness wrap said tool comprising:
a channel defined by mating sections that are adapted to receive one or more lengths of strand-like material, said tool having ridges arranged on a platform to receive a length of split harness wrap thereover, and means for gripping said tool to manipulate said harness over said material.

2. The tool recited in claim 1, wherein said channel is arranged along the length of said tool.

3. The tool recited in claim 1, wherein said channel is aligned with said ridges.

4. The tool recited in claim 1, wherein said channel is disposed angularly to said ridges.

5. The tool recited in claim 1, wherein the exit of said channel corresponds to the end of said platform for said harness wrap.

6. The tool recited in claim 1, wherein said tool is formed of a non-polar material.

7. The tool recited in claim 1, wherein said tool is formed of a polymer.

8. The tool recited in claim 1, wherein said tool is adapted to receive said strand-like material of varying diameters.

9. The tool recited in claim 1, wherein said tool is formed of a flexible material.

10. The tool recited in claim 1, wherein said tool has no parts in contact with said split harness wrap that will communicate electric charge to said means for gripping said tool.

11. The tool recited in claim 1, wherein said tool has no parts in contact with said strand-like material received in said channel that will communicate electric charge to said means for gripping said tool.

12. The tool recited in claim 1, wherein said channel is formed by the bending together of said mating sections.

13. The tool recited in claim 12, wherein said ridges are arranged on each of said mating sections.

14. The tool recited in claim 13, wherein each of said ridges define a track for guiding said harness wrap over said material.

15. The tool recited in claim 13, wherein said ridges of said mating sections are remote from said gripping means.

16. The tool recited in claim 13, wherein said mating section are positively closed together when wrapping said harness wrap over said material.

17. The tool recited in claim 12, wherein said material is encased in said channel.

18. The tool recited in claim 17, wherein said material is adapted to exit said harness wrap at any selected point along the length thereof when wrapped.

19. The tool recited in claim 12, wherein said tool has an entry end for said harness wrap and said ridges wedge said harness wrap open at said entry end.

20. The tool recited in claim 14 wherein said ridges are adapted to receive harness wrap of varying diameter.
